(19) United States
(12) Patent Application Publication
(10) Pub. No.: US 2007/0067347 A1
(43) Pub. Date: Mar. 22, 2007

(54) Method and apparatus for previewing recorded audio media

(76) Inventors: William W. Palbicki, Plymouth, MN (US); John C. Whaley, Eden Prairie, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/479,367

(22) Filed: Jun. 30, 2006

Related U.S. Application Data
(60) Provisional application No. 60/696,007, filed on Jul. 1, 2005.

(51) Int. Cl. G06F 17/00

(52) U.S. Cl. 707/104.1

(57) ABSTRACT

A method of previewing recorded audio media that allows a user or potential consumer to sample or preview the contents of recorded audio media, such as CDs, MP3 files, or audio tape. According to some embodiments, an apparatus is also provided for promoting the purchase of recorded audio media, and may include an electronic sound generating device incorporated on or within a recorded audio media packaging unit to provide a preview of the recorded audio signals.

### RELATED APPLICATION

The present application claims priority to U.S. Provisional Patent Application 60/696,007, filed Jul. 1, 2005, the entire disclosure of which is incorporated herein by reference.

### FIELD OF THE INVENTION

The invention relates to devices and methods for generating sampled sound signals. More particularly, the invention relates to devices and methods for previewing recorded audio media in conjunction with marketing of recorded audio media.

### BACKGROUND SECTION

Recorded audio media, such as music tapes and compact discs (CDs), have been marketed to consumers in a variety of ways, including retail display settings in stores and in shopping malls, by way of example. Today, CDs and other digital formats are widely used for recording and storing audio media, offering certain advantages such as clarity, ease of reproduction, and ease of locating information of interest (i.e., locating a particular recorded “track” or song).

The marketing of recorded audio media in retail display settings may, in certain cases, be facilitated by equipment that allows a potential consumer to “sample” or “preview” selected materials. Such equipment typically includes a “kiosk”-type arrangement that may include a pair of headphones mounted to a kiosk (i.e., a display case), and user-operated features, such as buttons that allow a potential purchaser to select a particular track on a particular music CD, for example, to listen the selections in conjunction with making a decision about purchasing the CD.

Existing kiosk-type systems tend to be relatively large, expensive structures that require a certain degree of upkeep, such as maintenance and cleaning, as well as the need to update (i.e., reprogram) the kiosk with different audio media as new or different material becomes available. There is also typically a limit to the number of user “stations” that may be installed in a given retail environment, limiting accessibility to those who may wish to preview a selection prior to purchasing. Other potential disadvantages to the kiosk-type systems is that they may discourage use by consumers who may be unfamiliar with their operation, or who may be concerned with the cleanliness of the headphones after use by others.

Electronic sound generating devices have been adapted for use in items including children's toys, such as stuffed animals or dolls and the like. Such electronic devices are typically small and relatively rugged. One such device is disclosed in U.S. Pat. No. 4,810,997 to Kudo et al., which is hereby incorporated by reference in its entirety. Electronic sound generating devices may include electronic circuitry and a sound generator shaped from a thin plate. The electronic circuitry may include a circuit element such as an integrated circuit chip for producing electrical signals corresponding to the desired sounds, a battery, a switch, and a printed circuit board on which the circuit element, the battery and the switch are mounted.

What is desired, therefore, is a method of previewing recorded audio media that overcomes the drawbacks of existing kiosk-type systems described above by incorporating the electronic sound generating device on or within the packaging material of the recorded audio media to facilitate the use thereof by potential purchasers in making purchase decisions.

### BRIEF SUMMARY SECTION

In certain embodiments of the invention, a method of previewing recorded audio media is provided which allows a user or potential consumer to sample or preview the contents of a recorded audio media unit (RAMU) without the need for external equipment or devices.

Certain embodiments of the invention provide a method of marketing recorded audio media in a retail-type setting.

Certain embodiments of the invention provide a method of marketing recorded audio media in a point-of-sale environment, such as the checkout line of a grocery store.

In certain embodiments of the invention, an apparatus for promoting the purchase of recorded audio media may include an electronic sound generating device incorporated on or within a recorded audio media packaging unit to provide a preview of the recorded audio signals.

Certain embodiments of the invention may include an apparatus adapted to provide a user with the ability to select a particular recording or track to preview from a given recorded audio media. Certain further embodiments of the invention provide a user of the apparatus with the ability to select a particular recording or track from any of a number of recorded audio media contained within a particular packaging unit. For example, a plurality of recorded audio media (i.e., a set of 4 music CDs, for example) may be housed within a single packaging unit. One or more electronic sound generating devices (ESGDs) may be incorporated within a packaging unit to allow a user to select and preview recordings from any or all of the recorded audio media contained within the packaging unit, for example.

### DETAILED DESCRIPTION SECTION

The following detailed description should be read with reference to the drawings, in which like elements in different drawings are numbered identically. The drawings depict selected embodiments and are not intended to limit the scope of the invention. It will be understood that embodiments shown in the drawings and described below are merely for illustrative purposes, and are not intended to limit the scope of the invention as defined in the claims.

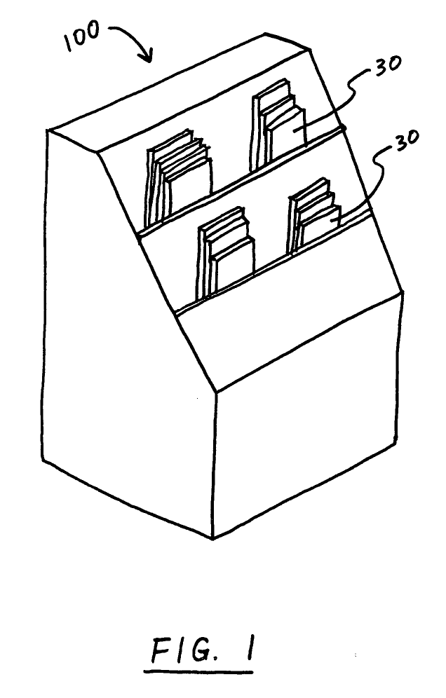

FIG. 1 is a perspective view of a display unit 100, such as a display rack, which may be used to display recorded audio media, such as tapes and CDs, to encourage purchase thereof by consumers. Such a display unit 100 may be situated within a music store, for example, or may be located in other retail-type environments such as kiosks or cart-stands in shopping malls, as well as at checkout lines in grocery stores, to name but two examples. A display unit 100 may encompass other ways of displaying recorded audio media to potential purchasers, such as in “bargain bins,” shopping carts, display shelves, etc.

Recorded audio media may encompass a wide variety of audio content and recording formats. For example, music CDs are contemplated as one example of recorded audio media, as are books on cassette tape. Where the recording format is a CD, for example, a single CD may comprise a recorded audio media unit (RAMU). One or more RAMUs (e.g., CDs) may be housed within a single “packaging unit” 30 for sale to consumers, such as is common with “boxed sets” that may include 2, 4, or more CDs, for example. Similarly, in the example where the recorded audio media format is a cassette tape, a single cassette may comprise the RAMU, and one or more cassettes may be housed within a single packaging unit 30. Other recording formats (such as DVDs, MP3 files, and other similar electronic audio files stored on a suitable memory device or recording medium), as well as other numbers and combinations of RAMUs within a packaging unit are contemplated and are considered to fall within the scope of the invention.

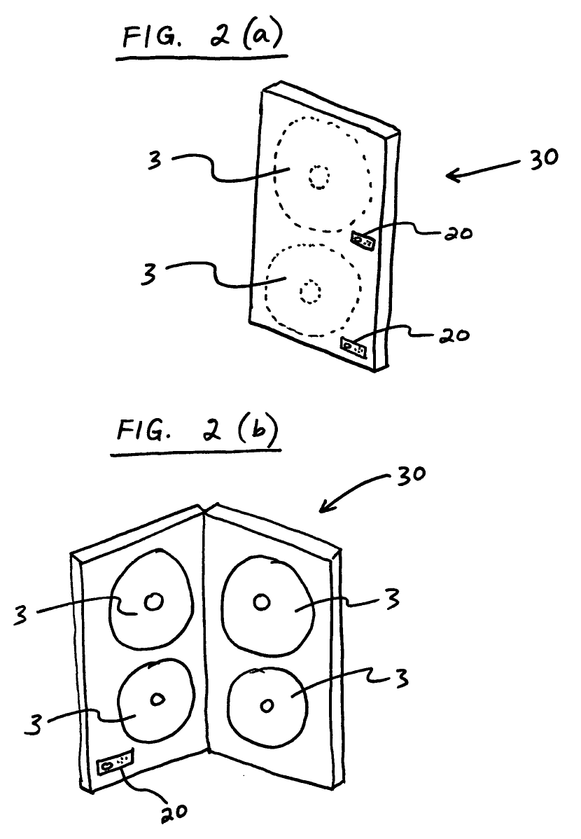

FIG. 2(a) shows an apparatus according to certain embodiments of the invention adapted to house a plurality of recorded audio media units (RAMUs), in this case CDs, within a single packaging unit 30, with an electronic sound generating device (ESGD) located thereon for providing a preview of the audio selections recorded thereon. In the example shown in FIG. 2(a), two RAMUs 3 (e.g., CDs) are housed within a packaging unit 30, and two ESGDs 20 are positioned on or within the packaging unit 30. With such an embodiment, each ESGD 20 could provide a potential purchaser with the ability to listen to a preview of the audio media recorded on an associated CD, for example.

In certain embodiments, such as the one shown in FIG. 2(b), a plurality of RAMUs 3 may be included within a single packaging unit 30 with a single ESGD 20 located thereon. In this embodiment, for example, a single ESGD may provide a user with the ability to listen to a preview of selections on any one or all of the four RAMUs (e.g., CDs) housed within the packaging unit 30 by, for example, pressing a button on the ESGD a certain number of times in succession, to allow the user to effectively “scroll” through the previews made available with the ESGD. Other combinations and configurations of ESGDs and RAMUs within a given packaging unit 30 may be envisioned by one of ordinary skill in the art without departing from the scope of the invention.

The previews provided by the ESGDs in accordance with certain embodiments of the invention may take a number of forms. For example, a typical RAMU, such as a music CD, has a number of “tracks” recorded thereon, corresponding to discrete selections (e.g., songs, in this example). A book on tape may also, by way of comparison, have a number of “tracks” corresponding to discrete selections (chapters of a book, for example). The previews, or “samples,” provided by the ESGDs in accordance with embodiments of the invention may typically comprise portions of selected tracks from the RAMUs, although it may be desirable in certain instances to play an entire track or tracks. The samples may comprise portions of tracks recorded on any or all of the RAMUs housed within a given packaging unit 30. Thus, an ESGD may be able to provide samples of tracks from all of the RAMUs within a packaging unit 30, or may be adapted to provide only samples of selected tracks based on marketing considerations.

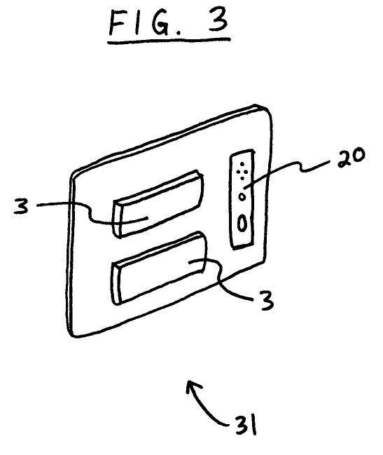

FIG. 3 shows an example of an alternate form of recorded audio media in a packaging unit 31. Alternate forms of recorded audio media may include audio media formats other than that found on CDs for example, and may include audio media formats either currently existing or to be developed in the future. Examples of currently existing audio media formats may include MP3 files and similar files, and file formats derived therefrom, as well as .wav and other similar digital audio file formats which may be suitable for storing on an ESGD 20. It may, for example, become desirable to package and sell recorded audio media in formats other than existing CD and CD-ROM formats. In FIG. 3, for example, a number of RAMUs 3 are shown, which may include storage media capable of recording MP3 files or other similar file types.

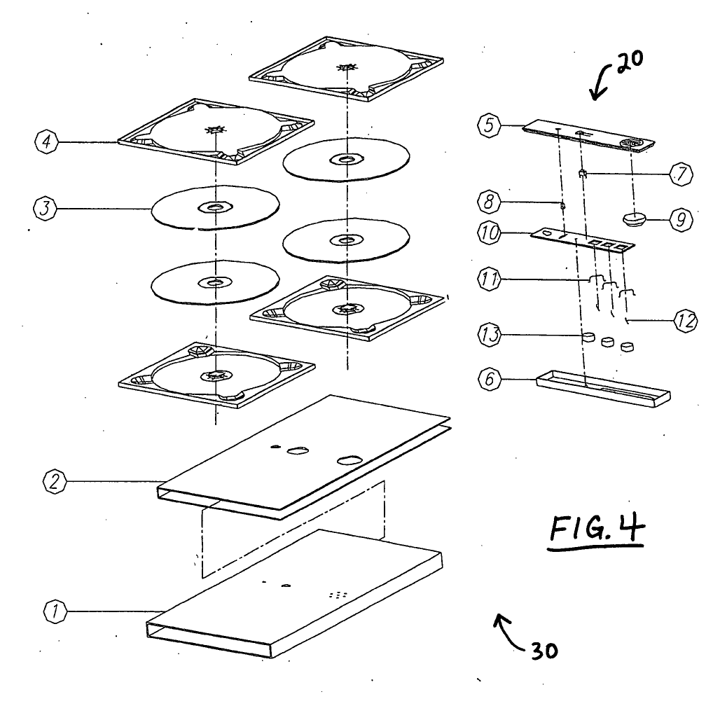

FIG. 4 shows an exemplary packaging unit 30 in accordance with certain embodiments of the invention. Packaging unit 30 may include a housing for holding one or more RAMUs 3. In the particular embodiment shown in FIG. 4, RAMU 3 comprises a CD, and packaging unit 30 includes a housing adapted to house four RAMUs. In some embodiments, the housing may comprise protective sleeve 1, cover 2, and mount 4 for detachably or removably securing one or more RAMUs. Packaging unit 30 may be further adapted to house ESGD 20 according to an embodiment of the invention. In one embodiment, packaging unit 30 is adapted to house ESGD 20 in a portion of packaging unit 30, such as within protective sleeve 1 and cover 2 as in the example shown in FIG. 4. As further shown in FIG. 4, packaging unit 30 may house ESGD 20 centrally with respect to the plurality of RAMUs contained therein.

According to an embodiment of the invention, ESGD 20 comprises a printed circuit board (PCB) 10 for housing the control electronics and memory for storing one or more samples of tracks from the RAMUs, as shown in FIG. 4. The samples may be stored in a digital format on the PCB 10, for example in a read-only memory (ROM) chip provided on PCB 10. ESGD 20 further comprises power source 13, such as button cell batteries or their equivalent, for providing power to PCB 10. Power source 13 may comprise other means for providing electrical power to PCB 10, such as with a solar panel, for example. ESGD 20 may further include switch 7 to allow a user to activate the ESGD 20 to provide samples of recorded audio media. ESGD 20 may further comprise sound generating means, such as by speaker 9. High spring 11 and low spring 12 contacts may optionally be included to provide electrical continuity between power source 13 and PCB 10, for example.

Switch 7 may comprise a pushbutton style On/Off switch for activating ESGD 20 responsive to a downward force exerted thereon, or may alternately comprise a touch-sensitive On/Off switch which activates ESGD 20 in response to a user touching switch 7 with a fingertip, for example. Other means of closing the switch 7 to activate ESGD 20 may be envisioned and will be deemed to fall within the scope of the invention.

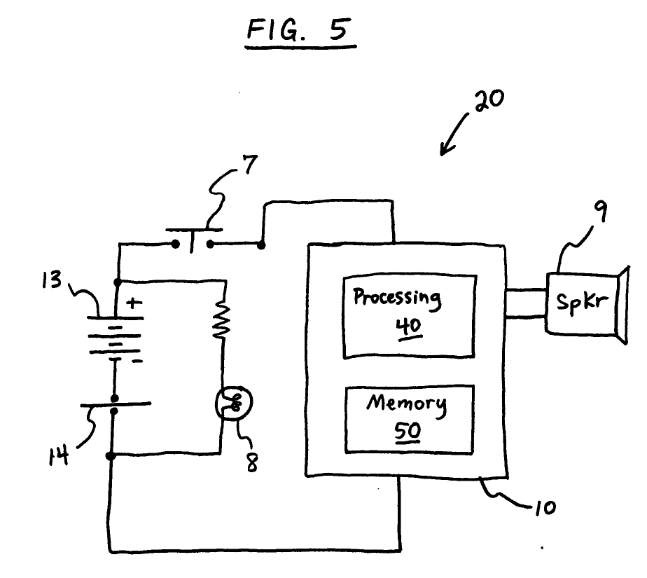

In yet a further embodiment of the invention, ESGD 20 may have an insulating strip 14 (see FIG. 5) placed on or near power source 13 to prevent current drain from power source 13, for example to save battery power between time of manufacture and time of placement of the packaging unit 30 in a retail setting. The insulating strip may, for example, be a plastic strip that insulates the power source 13 from the PCB 10 while extending outside the packaging unit 30 such that it can be grasped and removed by a retailer when ready to place on display. ESGD 20 may also be configured to have an LED 8 (see FIG. 4) for indicating the presence and availability of power source 13. For example, LED 8 could be adapted to illuminate upon removal of the insulating plastic strip mentioned above, indicating the availability of electrical power, and may be adapted to extinguish upon depletion of electrical energy from power source 13. Such a feature may, for example, be useful to a retailer who may grow weary of explaining why certain ESGDs are no longer providing the samples requested by prospective consumers. Alternately, LED 8 could be adapted to illuminate only while playing back a sample, or when some error or malfunction has occurred. These and other various embodiments are considered to be within the scope of the invention.

With continued reference to FIG. 4, ESGD 20 may further comprise upper and lower cover members 5, 6 to house the associated componentry described above. As shown, upper cover member 5 may include openings or fittings, for example to accommodate viewing LED 8 from outside of packaging unit 30, as well as to accommodate user access to switch 7 and speaker 9 for the desired input and output interface. Lower cover 6 may simply provide an enclosure for ESGD 20, or may be adapted to form portions of the electrical circuitry associated with ESGD 20. Of course, upper and lower cover members 5, 6 may be formed of a single member, or of a plurality of members, and each may incorporate some or all of the features of the other as described above. In some embodiments, upper or lower cover member 5 or 6, or both, may have an adhesive applied to a surface thereof to facilitate placement of the ESGD 20 on or within the packaging unit 30.

FIG. 5 shows a schematic diagram of ESGD 20. ESGD 20 has a PCB 10 which may contain processing means 40 and memory means 50. PCB 10 receives electrical power from power source 13 when switch 7 is closed. In an alternate embodiment (not shown), momentary closure of switch 7 may cause closure of an associate contact that remains closed to continue to supply power from power source 13 to PCB 10 until the ESGD 20 has completed playing back a given sample, for example. The addition of such temporary switch closure configurations are known in the art and are contemplated as being within the scope of the invention. Processing means 40 may comprise any microchip or integrated circuit chip technology, as is known in the art. Processing means 40 is adapted to receive as its input one or more switch closure signals upon actuation of switch 7 by a user. Processing means 40 may then select a “sample” from memory means 50 to play back to the user via speaker 9. Memory means 50 may comprise electronic storage media, such as a read-only memory (ROM) chip or the like. In one embodiment, processing means 40 may be adapted to allow a user to “scroll” through the various samples stored in the memory means 50, for example by pressing on switch 7 several times in succession. In one possible embodiment of the invention, insulating strip 14 may be included to preserve the longevity of power source 13. In the example shown in FIG. 5, removal of insulating strip 14 would illuminate LED 8 to indicate the availability of electrical power for generating samples. However, one of ordinary skill in the art would recognize that this arrangement is exemplary, and other useful placements of insulating strip 14 and/or LED 8 may be arrived at with the benefit of applicant's teachings.

Since the amount of audio material (i.e., the number and length of samples) that may be replayed by ESGD 20 for previewing purposes is limited by cost and space limitations (i.e., the amount of memory available in memory means 50), it may be desirable to reduce the amount of memory needed to store a particular sample by possibly using different file formats, either alone or in conjunction with file compression techniques. Certain techniques may be utilized that greatly reduce the memory requirements, while perhaps sacrificing a certain amount of audio fidelity. This may be acceptable for the intended previewing application since a potential customer may not expect the sound quality of the samples to be as good as that contained on the actual recorded audio media. Conversely, it may be the case that portions of the actual recorded audio media can be easily and cost-effectively reproduced within memory means 50 such that no alteration of format is desired. The choice of storage format within memory means 50 is a matter of design choice, since it incorporates issues related to costs and marketing, and no single format may be considered “best” for any given application.

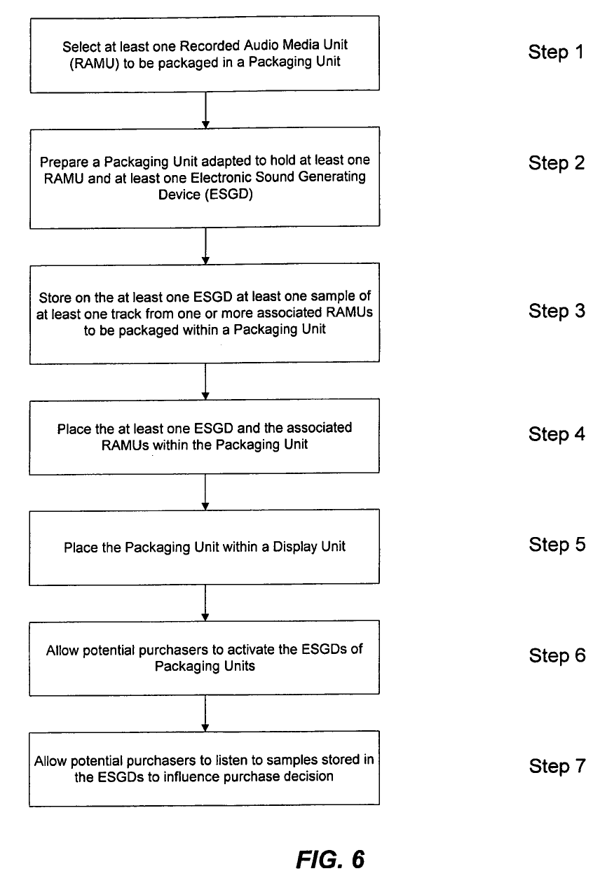

FIG. 6 is a flow chart illustrating a method of marketing recorded audio media in accordance with an embodiment of the invention. Step 1 may include selecting at least one RAMU 3 to be packaged in a Packaging Unit 30. Note that step 1 does not take into account any intellectual property issues associated with the recorded audio media, such as copyright ownership; such issues should normally be addressed and resolved prior to beginning Step 1. Step 2 may include preparing (or manufacturing) a Packaging Unit 30 that is adapted to hold at least one RAMU 3 and at least one ESGD 20. Step 3 may include storing at least one sample of at least one track from one or more RAMUs in the at least one ESGD 20 to be packaged within a Packaging Unit 30. Storing a sample in the ESGD 20 may simply involve copying digital information as it exists on an RAMU 3 into the memory means 50 (such as a ROM chip) of the ESGD 20. Storing a sample in the ESGD 20 may optionally involve transforming the information on the RAMU 3 into a sample capable of storage in the memory means 50 of ESGD 20. Step 4 may include placing the at least one ESGD 20 and the associated RAMUs within the Packaging unit 30. Step 5 may include placing the Packaging unit 30 within a Display unit 100. As noted earlier, the term “Display Unit” may encompass display racks, such as that shown in FIG. 1, as well as display shelves, “bargain bins,” shopping carts, etc., or any similar means of presenting the Packaging Unit to potential purchasers. Step 6 may include allowing potential purchasers to activate the ESGDs of Packaging Units. This step may further comprise encouraging potential purchasers to activate the ESGDs of Packaging Units, such as by providing advertising signage nearby with instructions for use. Step 7 may include allowing potential purchasers to listen to samples stored in the ESGDs and to thereby influence their purchase decisions.

Thus, embodiments of A METHOD AND APPARATUS FOR PREVIEWING RECORDED AUDIO MEDIA are disclosed. One skilled in the art will appreciate that the present invention can be practiced with embodiments other than those disclosed. The disclosed embodiments are presented for purposes of illustration and not limitation.

What is claimed is:

1. An apparatus for previewing recorded audio media comprising:
a packaging unit adapted to house a plurality of recorded audio media units (RAMUs); and
an electronic sound generating device (ESGD) mounted to the packaging unit and adapted to produce samples of audio signals representative of the tracks stored on the RAMUs to be housed by the packaging unit,
wherein the ESGD comprises a power source, means for activating the ESGD, processing means, memory means, and a means for producing sounds.

2. The apparatus of claim 1 wherein the ESGD is adapted to produce samples of audio signals representative of the tracks stored on the RAMUs in response to user activation.

3. The apparatus of claim 2 wherein user activation comprises touching a portion of the ESGD.

4. The apparatus of claim 2 wherein user activation comprises depressing a pushbutton switch of the ESGD.

5. The apparatus of claim 1 wherein the RAMUs comprise music compact discs (CDs).

6. The apparatus of claim 5 wherein the packaging unit is adapted to hold a 2-disc collection of music CDs.

7. The apparatus of claim 5 wherein the packaging unit is adapted to hold a 4-disc collection of music CDs.

8. An apparatus for allowing a user to preview recorded audio media, the apparatus comprising:
a packaging unit adapted to house one or more recorded audio media units (RAMUs), the RAMUs having one or more audio tracks stored thereon; and
an electronic sound generating device (ESGD) coupled to the packaging unit, the ESGD comprising a power source, a switch for activating the ESGD, processing circuitry, memory, and a speaker, the ESGD being adapted to produce an audio signal sample representative of the audio tracks stored on the RAMUs.

9. The apparatus of claim 8 wherein the ESGD is adapted to produce the audio signal sample in response to user activation of the switch.

10. The apparatus of claim 8 wherein the one or more RAMUs include a music compact disc (CD).

11. The apparatus of claim 8 wherein the one or more RAMUs include a DVD.

12. The apparatus of claim 8 wherein the one or more RAMUs include an electronic storage device.

13. The apparatus of claim 12 wherein the electronic storage device contains one or more electronic audio files.

14. The apparatus of claim 8 wherein the one or more RAMUs include an audio cassette tape.

15. The apparatus of claim 10 wherein the packaging unit is adapted to house a 2-disc collection of music CDs.

16. The apparatus of claim 10 wherein the packaging unit is adapted to house a 4-disc collection of music CDs.

17. The apparatus of claim 9 wherein the ESGD is adapted to allow a user to scroll through a plurality of audio signal samples in response to successive user activations.

18. The apparatus of claim 9 wherein the ESGD is adapted to allow a user to produce an audio signal sample from more than one RAMU.

19. The apparatus of claim 8 wherein the packaging unit comprises:
a protective sleeve, and
a mount for removably securing one or more RAMUs,
wherein the ESGD is adapted to be housed within the protective sleeve.

20. A method of marketing recorded audio media comprising:
providing a packaging unit adapted to house at least one recorded audio media unit (RAMU) and at least one electronic sound generating device (ESGD);
storing at least one sample of at least one track from the at least one RAMU in the at least one ESGD to be packaged within the packaging unit;
placing the at least one ESGD and the at least one RAMU within the packaging unit; and
placing the packaging unit within a display unit, the display unit being adapted to allow potential purchasers to activate the ESGDs and listen to samples from the ESGDs.
